(19) United States
(12) Patent Application Publication
(10) Pub. No.: US 2004/0111648 A1
(43) Pub. Date: Jun. 10, 2004

(54) System, apparatus, terminal, method, and computer program for managing information

(76) Inventor: Hirotoshi Fujisawa, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/670,281

(22) Filed: Sep. 26, 2003

(30) Foreign Application Priority Data
Oct. 11, 2002 (JP) P2002-298292

(51) Int. Cl. H04L 9/32

(52) U.S. Cl. 713/202

(57) ABSTRACT

An information management apparatus generates an authentication image based on information registered by a user, and issues the authentication image to an information processing terminal owned by the user. When the user purchases a commodity in a store and shows the authentication image, the information processing terminal transfers the authentication image to a retailer terminal. The retailer terminal requests the information management apparatus to authenticate the authentication image. If the information management apparatus verifies that the authentication image is authentic, the information management apparatus generates a new authentication image instead of the authentication image displayed on the information processing terminal. The new authentication image is then sent through the retailer terminal to the information processing terminal. The present invention is applicable to an apparatus that is used when the user requires to identify himself.

### BACKGROUND OF THE INVENTION

1. Field of the Invention

The present invention relates to a system, apparatus, terminal, method, and computer program for managing information. In particular, the present invention relates to a system, apparatus, terminal, method, and computer program for increasing sales by arousing user interest to user identification information.

2. Description of the Related Art

A variety of techniques have been proposed to authenticate a holder of cards such as a credit card, a commuter pass, or a member's card issued by a particular store. Such a card stores information that is visually recognized and information that is mechanically recognized.

For example, Japanese Unexamined Patent Application Publication No. 2001-312595 discloses an authentication system. In the authentication system, a facial portrait and a fingerprint, identifying an owner of an IC card, are engraved on the IC card. An IC chip mounted on the IC card stores data of a facial portrait image and a finger print image. A person, to whom the holder shows the IC card, thus authenticate the holder visually and mechanically.

Japanese Unexamined Patent Application Publication No. 2001-52142 discloses another authentication system. In this authentication system, additional information representing features acquired from a facial portrait of a user is printed together with the facial portrait on the surface of an IC card. Even if the facial portrait is counterfeited by a third party, the additional information is used to detect a counterfeit.

In these authentication systems, information representing the user is physically presented (engraved or printed) on the surface of the IC card. The user is thus reliably authenticated based on the information held in the card. The information on the IC card is not easily rewritten.

If the information represented on the surface of the card is gradually changed as the card is used more, the IC card continuously draws user's attention.

### SUMMARY OF THE INVENTION

Accordingly, it is an object of the present invention to invite a user to use information identifying the user.

In a first aspect of the present invention, an information management system includes an information management apparatus for producing an authentication image to be used to authenticate a user, and an information processing terminal for displaying the authentication image provided by the information management apparatus. The information management apparatus includes a generating unit for generating a first authentication image based on a predetermined original image, a first providing unit for providing the information processing terminal with the first authentication image generated by the generating unit, an authenticating step for authenticating the first authentication image which is provided by the information processing terminal through a control device that controls the reading of an image displayed on the information processing terminal, and a display control unit for displaying a second authentication image instead of the first authentication image displayed on the information processing terminal when the authenticating unit verifies that the first authentication image is authentic.

The information processing terminal includes a acquisition unit for acquiring the first authentication image, a display unit for displaying the first authentication image acquired by the acquisition unit, and a second providing unit for providing the information management apparatus with the first authentication image, displayed by the display unit, through the control device, wherein the display unit displays the second authentication image instead of the first authentication image when the information management apparatus verifies that the first authentication image provided by the second providing unit is authentic.

In a second aspect of the present invention, an information management method for an information management system including an information management apparatus for producing an authentication image to be used to authenticate a user, and an information processing terminal for displaying the authentication image provided by the information management apparatus. The information management method includes an information management method for the information management apparatus, and an information processing method for the information processing terminal. The information management method for the information management apparatus includes a generating step for generating a first authentication image based on a predetermined original image, a first providing step for providing the information processing terminal with the first authentication image generated in the generating step, an authenticating step for authenticating the first authentication image which is provided by the information processing terminal through a control device that controls the reading of an image displayed on the information processing terminal, and a display control step for displaying a second authentication image instead of the first authentication image displayed on the information processing terminal when the authenticating step verifies that the first authentication image is authentic. The information processing method for the information processing terminal includes an acquisition step for acquiring the first authentication image, a display step for displaying the first authentication image acquired in the acquisition step, and a second providing step for providing the information management apparatus with the first authentication image, displayed in the display step, through the control device, wherein the display step includes displaying the second authentication image instead of the first authentication image when the information management apparatus verifies that the first authentication image provided in the second providing step is authentic.

In a third aspect of the present invention, an information management apparatus for generating an image to be displayed on a predetermined information processing terminal includes a generating unit for generating a first authentication image to be used to authenticate a user based on a predetermined original image, a providing unit for providing the information processing terminal with the first authentication image generated by the generating unit, an authenticating unit for authenticating the first authentication image which is provided by the information processing terminal through a control device that controls the reading of an image displayed on the information processing terminal, and a display control unit for displaying a second authentication image instead of the first authentication image displayed on the information processing terminal when the authenticating unit verifies that the first authentication image is authentic.

Preferably, the generating unit generates further the second authentication image when the authentication unit verifies that the first authentication image is authentic, and the display control unit displays the second authentication image on the information processing terminal by providing the information processing terminal with the second authentication image generated by the generating unit.

Preferably, the generating unit generates the first authentication image containing first amount information based on a first amount of money already paid by the user.

Preferably, the generating unit subtracts an amount spent by the user from the amount represented by the first amount information when the authenticating unit verifies that the first authentication image is authentic, and generates the second authentication image containing second amount information based on a resulting remaining amount of money.

Preferably, the first authentication image and the second authentication image constitute a continuous scene.

Preferably, each of the first authentication image and the second authentication image is one of a still image and a moving image.

In a fourth aspect of the present invention, an information management method for an information management apparatus includes a generating step for generating a first authentication image to be used to authenticate a user based on a predetermined original image, a providing step for providing the information processing terminal with the first authentication image generated in the generating step, an authenticating step for authenticating the first authentication image which is provided by the information processing terminal through a control device that controls the reading of an image displayed on the information processing terminal, and a display control step for displaying a second authentication image instead of the first authentication image displayed on the information processing terminal when the authenticating step verifies that the first authentication image is authentic.

In a fifth aspect of the present invention, a first computer program includes a generating step for generating a first authentication image to be used to authenticate a user based on a predetermined original image, a providing step for providing the information processing terminal with the first authentication image generated in the generating step, an authenticating step for authenticating the first authentication image which is provided by the information processing terminal through a control device that controls the reading of an image displayed on the information processing terminal, and a display control step for displaying a second authentication image instead of the first authentication image displayed on the information processing terminal when the authenticating step verifies that the first authentication image is authentic.

In a sixth aspect of the present invention, an information processing terminal includes an acquisition unit for acquiring a first authentication image generated based on a predetermined original image, a display unit for displaying the first authentication image acquired by the acquisition unit, and a providing unit for providing the information management apparatus with the first authentication image, displayed by the display unit, through a control device that controls the reading of an image, wherein the display unit displays the second authentication image instead of the first authentication image when the information management apparatus verifies that the first authentication image provided by the providing unit is authentic.

Preferably, the acquisition unit further acquires the second authentication image from the information management apparatus when the first authentication image provided by the providing unit is verified as being authentic, and the display unit displays the second authentication image acquired by the acquisition unit instead of the first authentication image.

Preferably, the first authentication image contains first amount information based on a first amount of money already paid by the user.

Preferably, the second authentication image contains second amount information based on a remaining amount which is obtained by subtracting an amount spent by the user from the amount represented by the first amount information.

In a seventh aspect of the present invention, an information processing method for an information processing terminal includes an acquisition step for acquiring a first authentication image generated based on a predetermined original image, a display step for displaying the first authentication image acquired in the acquisition step, and a providing step for providing the information management apparatus with the first authentication image, displayed in the display step, through a control device that controls the reading of an image, wherein the display step includes displaying the second authentication image instead of the first authentication image when the information management apparatus verifies that the first authentication image provided in the providing step is authentic.

In an eighth aspect of the present invention, a second computer program includes an acquisition step for acquiring a first authentication image generated based on a predetermined original image, a display step for displaying the first authentication image acquired in the acquisition step, and a providing step for providing the information management apparatus with the first authentication image, displayed in the display step, through a control device that controls the reading of an image, wherein the display step includes displaying the second authentication image instead of the first authentication image when the information management apparatus verifies that the first authentication image provided in the providing step is authentic.

In accordance with preferred embodiments of the present invention, the first authentication image is generated based on the predetermined original image, the generated authentication image is then transferred to the information processing terminal. The information management apparatus authenticates the first authentication image which is provided by the information processing terminal through the control device that controls the reading of the image displayed on the information processing terminal. If the first authentication image is verified as being authentic, the information processing terminal displays the second authentication image instead of the first authentication image.

In accordance with preferred embodiments of the present invention, the first authentication image is acquired, the acquired first authentication image is then displayed, and the displayed first authentication image is provided to the information management apparatus through the control device. When the information management apparatus verifies that the first authentication image is authentic, the second authentication image is displayed instead of the first authentication image.

### BRIEF DESCRIPTION OF THE DRAWINGS

FIG. 1 shows a system configuration of an information management system implementing the present invention;

FIG. 2 shows an image contained in an authentication image;

FIG. 3 shows another image contained in an authentication image;

FIG. 4 shows an authentication image;

FIG. 5 shows another authentication image;

FIG. 6 shows yet another authentication image;

FIG. 7 is a block diagram of an information processing terminal of FIG. 1;

FIG. 8 is a functional block diagram of the information processing terminal of FIG. 7;

FIG. 9 is a block diagram of an information management apparatus of FIG. 1;

FIG. 10 is a functional block diagram of the information management apparatus of FIG. 9;

FIG. 11 is a block diagram of a retailer terminal of FIG. 1;

FIG. 12 is a functional block diagram of the retailer terminal of FIG. 11;

FIG. 13 is a flow diagram showing an authentication image issue requesting process of the information processing terminal;

FIG. 14 is a flow diagram showing an authentication image issuing process which is performed by the information management apparatus in response to the process shown in FIG. 13;

FIG. 15 is a flow diagram showing an authentication process of the information processing terminal;

FIG. 16 is a flow diagram showing an authentication requesting process which is performed by the retailer terminal in response to the process shown in FIG. 15;

FIG. 17 is a flow diagram showing an authentication process which is performed by the information management apparatus in response to the process shown in FIG. 16;

FIG. 18 shows an example of the authentication image;

FIG. 19 shows another example of the authentication image;

FIG. 20 shows yet another example of the authentication image;

FIG. 21 shows another system configuration of the information management system in accordance with one embodiment of the present invention;

FIG. 22 is a flow diagram showing an authentication image issue requesting process which is performed by an information processing terminal of FIG. 21;

FIG. 23 is a flow diagram showing an authentication image issuing process which is performed by the information management apparatus in response to the process of FIG. 22;

FIG. 24 is a flow diagram showing an authentication requesting process performed by a retailer terminal of FIG. 21; and

FIG. 25 is a flow diagram showing an authentication process which is performed by the information management apparatus in response to the process of FIG. 24.

### DESCRIPTION OF THE PREFERRED EMBODIMENTS

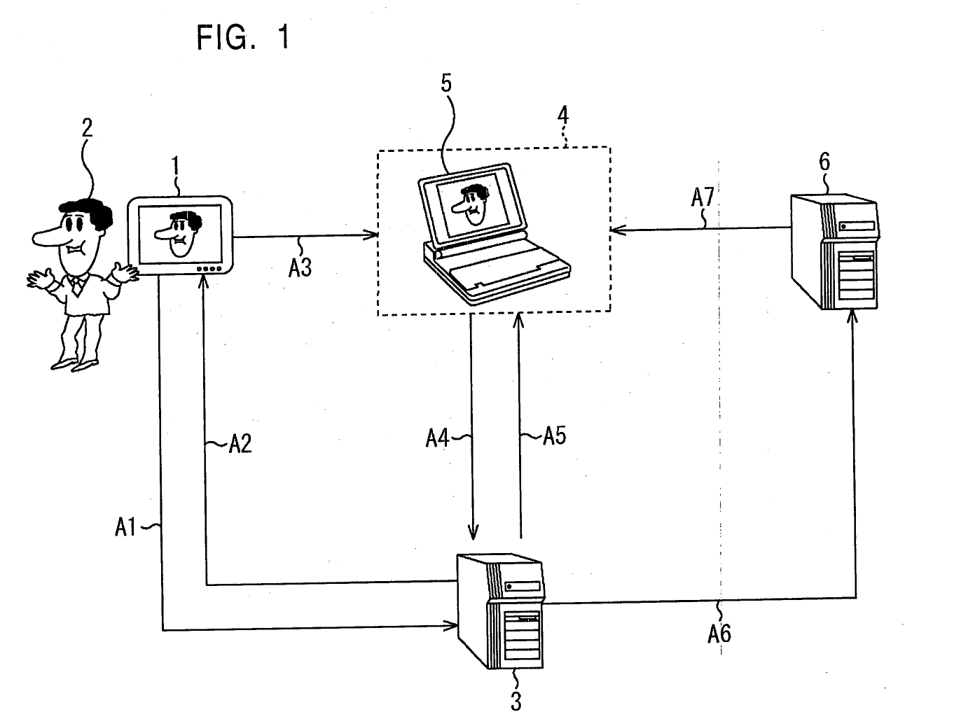

FIG. 1 shows a system configuration of an information management system of one embodiment of the present invention.

An information processing terminal 1 is used by a user 2. The display of the information processing terminal 1 presents a predetermined original image selected by the user 2 and an authentication image an information management apparatus 3 generates based on accompanying information such as an image of a fingerprint of the user 2 and a password of predetermined digits.

The authentication image displayed on the information processing terminal 1 is used to identify the user 2 who is a holder of the information processing terminal 1. With the authentication image held in the information processing terminal 1, the user 2 registers the original image and the accompanying information to the information management apparatus 3 through a network such as the Internet, and requests the information management apparatus 3 to issue the authentication image (see an arrow-headed solid line A1 in FIG. 1).

The information management apparatus 3 generates the authentication image based on the original image and the accompanying information sent from the information processing terminal 1, and transmits (issues) the generated authentication image to the information processing terminal 1 through the network (an arrow-headed solid line A2).

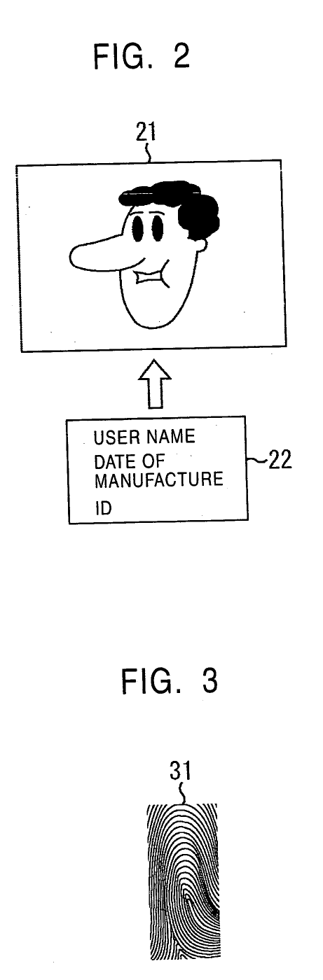

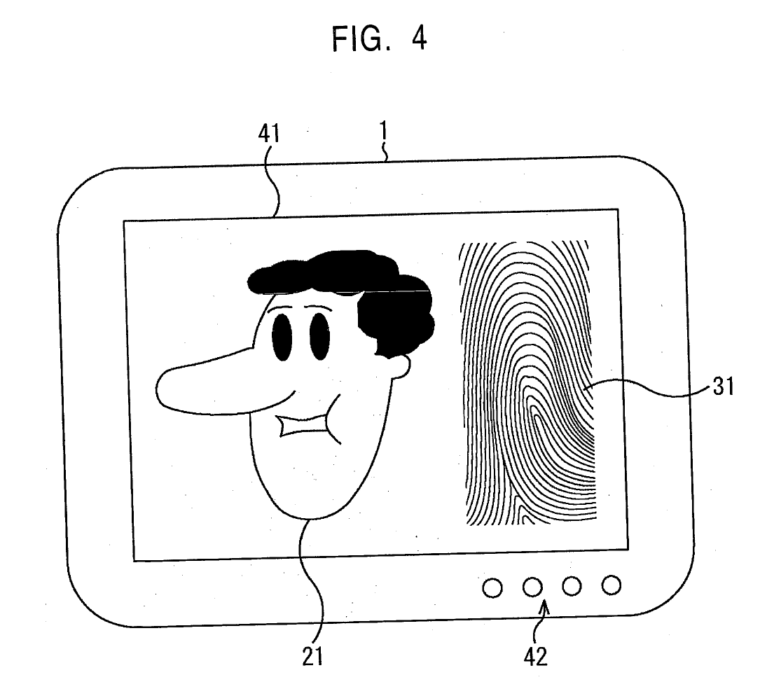

If the user 2 selects a facial portrait 21 of the user 2 as an original image to be registered in the information management apparatus 3 as shown in FIG. 2, the information management apparatus 3 adds, to the facial portrait 21, the name of the user, the year, the month, and the date of manufacture, and the identification (ID) as watermark information 22. Furthermore, the accompanying information, such as the fingerprint image of the user 2 and the password having predetermined digits is encoded and acquired as an additional information image 31 shown in FIG. 3 and is added to the facial portrait 21 having the watermark information 22 attached thereto.

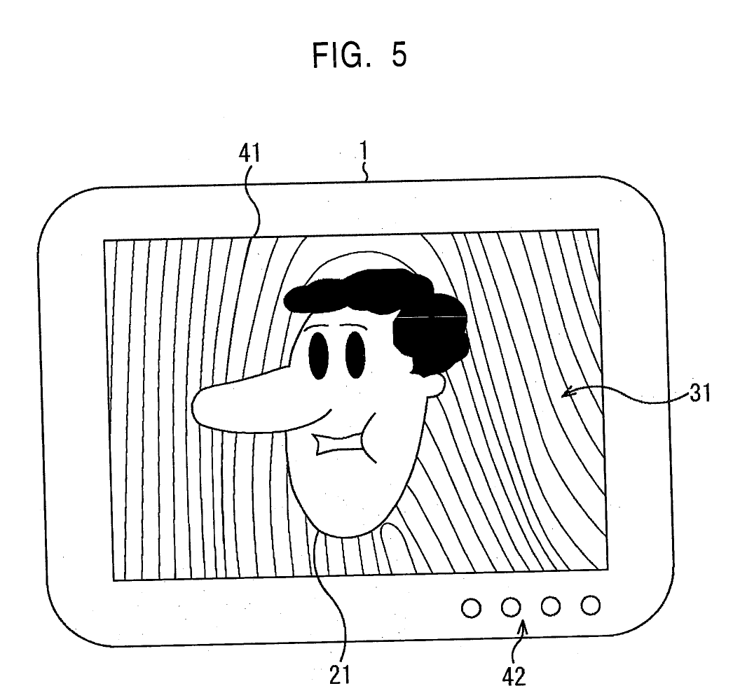

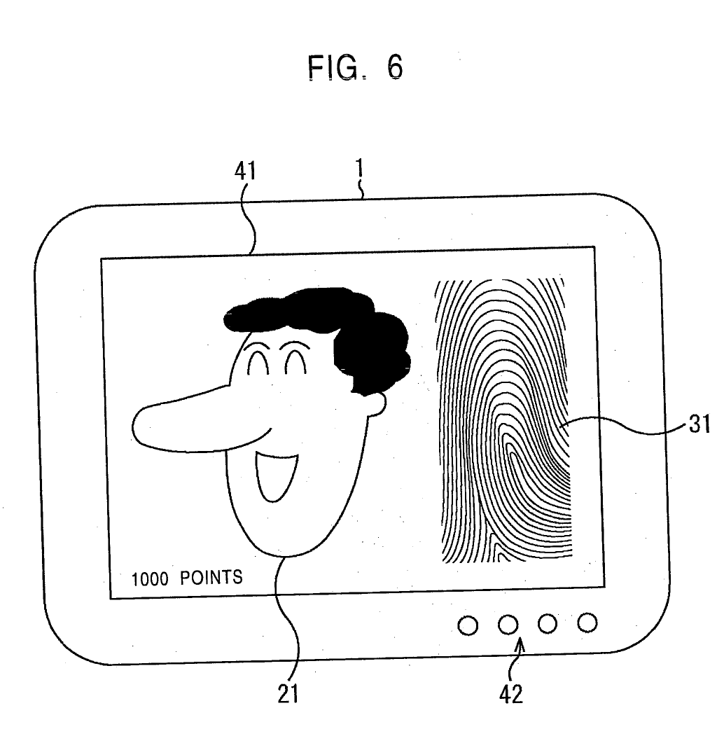

The information processing terminal 1, which has captured the authentication image generated by the information management apparatus 3, displays the authentication image as shown in one of FIGS. 4 and 5.

As shown in FIG. 4, the authentication image is displayed on a display 41 with the facial portrait 21 (the original image with the watermark information attached thereto) and the additional information image 31 separately presented on the left-hand side and the right-hand side of the display 41. As shown in FIG. 5, the authentication image is presented on the display 41. The additional information image 31 is presented on the entire display 41 while the facial portrait 21 is superimposed on the additional information image 31.

The facial portrait 21 (the original image) and the additional information image 31, forming the authentication image, are related to each other. When an attempt is made to separate the facial portrait 21 from the additional information image 31, the watermark information attached to the facial portrait 21 and the fingerprint information of the user 2 as source data of the additional information image 31 may be set to be undecryptable.

A generating algorithm of the authentication image may be modified. The authentication image may be generated based on the original image selected according to the user's own preference.

The display 41 of the information processing terminal 1 shown in FIGS. 4 and 5 is an liquid-crystal display (LCD). Available on the bottom side of the display 4 is an input unit 42 including a button for requesting an issue of the authentication image, and a button operated to transfer the authentication image to a retailer terminal 5 shown in FIG. 1.

Returning to FIG. 1, the user 2 identifies himself at a retailer store 4 using the authentication image displayed on the information processing terminal 1. The user 2 causes the retailer terminal 5 installed at the retailer store 4 to capture the authentication image and instructs the retailer terminal 5 to authenticate the authentication image (an arrow-headed solid line A3).

To capture the authentication image into the retailer terminal 5, the user 2 may go to the retailer store 4 to use wired or wireless communications performed between the information processing terminal 1 and the retailer terminal 5. Alternatively, the user 2 may use a network without directly visiting the retailer store 4. Alternatively, an authentication image captured by a scanner (not shown) may be transmitted to the retailer terminal 5.

The authentication image displayed on the information processing terminal 1 may be used when the user 2 indicates a membership of the retailer store 4 or when the user 2 purchases and pays for a commodity at the retailer store 4. The authentication image serves as a membership card of the retailer store 4 or a credit card of the user 2.

The authentication image captured by the retailer terminal 5 is transmitted from the retailer terminal 5 to the information management apparatus 3 through a network, and the retailer terminal 5 requests the information management apparatus 3 to authenticate the authentication image (see an arrow-headed solid line A4).

The information management apparatus 3 verifies the authenticity of the authentication image transmitted from the retailer terminal 5 based on the original image pre-registered by the user 2 and the accompanying information (information used to generate the authentication image). The information management apparatus 3 then notifies the retailer terminal 5 of the result of verification, namely, as to whether or not the authentication image is authentic (see an arrow-headed solid line A5).

Since the retailer terminal 5 displays the verification result based on the notification from the information management apparatus 3, a shop clerk may determine whether the user 2 is the authentic user of the information processing terminal 1 (the authentication image). If the authentication image is counterfeited, for example, if the facial portrait is rewritten, the information management apparatus 3 determines based on the pre-registered information whether the reported authentication image is not authentic.

When the authentication image is used at the retailer store 4, the information management apparatus 3 transmits an authentication image, to be newly displayed on the information processing terminal 1, together the verification result to the information processing terminal 1. The retailer terminal 5 rewrites the authentication image displayed on the information processing terminal 1 (the authentication image that has been authenticated).

If a plurality of facial portraits are pre-registered as original images, the authentication image already displayed is rewritten by a next one of the authentication images generated based on the facial portraits each time the user 2 uses the retailer store 4 (each time the authentication image is authenticated).

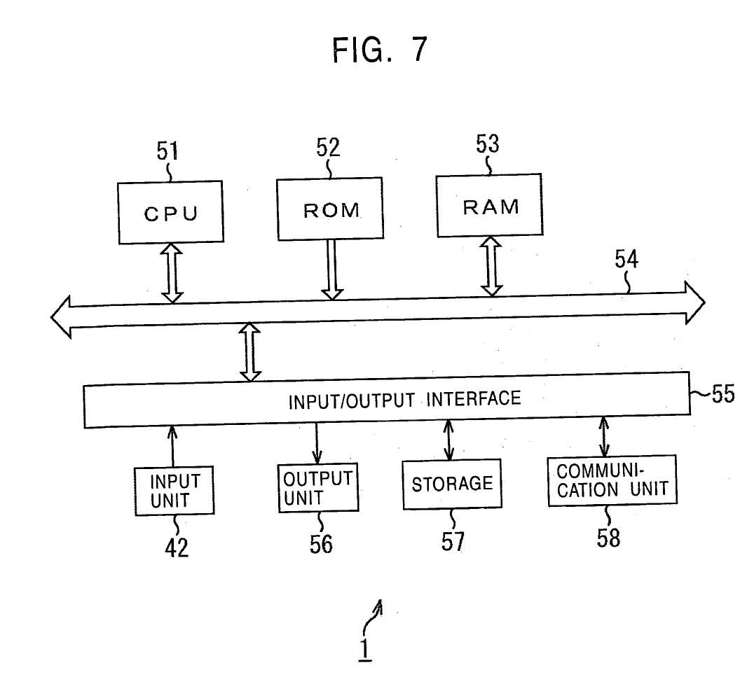

FIG. 6 shows a new authentication image which results when the authentication image shown in FIG. 4 is determined as being authentic. In comparison with FIG. 4, the facial portrait 21 is modified. The phrase “1000 points” indicate the number of points the retailer store 4 has issued in accordance with a paid amount. The characters or drawings representing the number of points may be contained in the authentication image in an invisible way rather than in the visible way shown in FIG. 6.

The authentication image already displayed may be replaced with one of a variety of authentication images generated by the information management apparatus 3. For example, not only the facial portrait image but also the color of the entire authentication image may be changed. The additional information image 31 may be rewritten depending the usage of the information processing terminal 1 by the user 2. A new authentication image generated by the information management apparatus 3 and expected to replace the already displayed authentication image is referred to as an update image as appropriate.

Since the authentication image is rewritten each time the user 2 uses the information processing terminal 1, a user's interest to a next change in the authentication image is aroused. The user is thus invited to frequently use the authentication image (the information processing terminal 1). In other words, by allowing the user 2 to use the authentication image in the retailer store 4, a rise in sales at the retailer store 4 is expected.

When the user 2 purchases a commodity at the retailer store 4, information concerning the payment for the purchased commodity is transmitted to the information management apparatus 3 from the retailer terminal 5. When the authentication image is verified as being authentic, the information management apparatus 3 requests a billing apparatus 6 managed by a bank, for example, to pay for the commodity (see an arrow-headed solid line A6).

The billing apparatus 6 debits a predetermined bank account of the user 2 by the charge for the commodity. When the payment is completed, the billing apparatus 6 so notifies the retailer terminal 5 (see an arrow-headed solid line A7).

In the above discussion, the facial portrait of the user 2 is contained in the authentication image on the information processing terminal 1. For example, if a person such as a shop clerk, to whom the authentication image is shown, does not need to visually recognize the user of the information processing terminal 1 (only needs to determine whether the authentication image displayed on the information management apparatus 3 is authentic), a variety of original images other than the facial portrait may be used.

The authentication image presented on the information processing terminal 1 may be successively rewritten depending on the usage of the authentication image displayed on the information processing terminal 1. The user's interest to the authentication image is aroused, thereby leading to frequent uses of the authentication image at the retailer store 4.

An operation of the information management system shown in FIG. 1 will now be discussed in detail with reference to flow diagrams.

FIG. 7 is a block diagram showing the structure of the information processing terminal 1 of FIG. 1.

For example, the information processing terminal 1 may be one of a personal digital assistant (PDA), a cellular telephone, and a notebook computer.

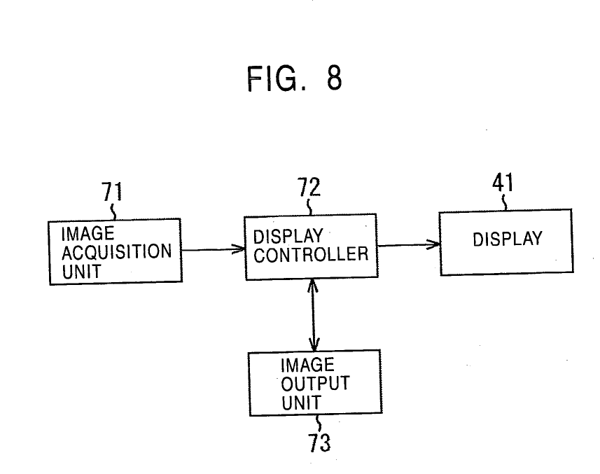

A central processing unit (CPU) 51 performs a variety of processes in accordance with a program stored in a read-only memory (ROM) 52, and a program which is loaded into a random access memory (RAM) 53 from a storage 57. The function of the information processing terminal 1, which is executed when the CPU 51 performs the predetermined program, is discussed with reference to FIG. 8. The RAM 53 stores, as necessary, data required by the CPU 51 in the execution of the variety of processes.

The CPU 51, the ROM 52, and the RAM 53 are interconnected through a bus 54. The bus 54 is also connected to an input/output interface 55.

Also connected to the input/output interface 55 are the input unit 42 composed of a plurality of buttons shown in FIGS. 4 and 5, the display 41, an output unit 56 such as a loudspeaker, the storage 57 such as a hard disk, and a communication unit 58 including a modem, a terminal adaptor, and a wireless communication module. Communications with the information management apparatus 3 through a network or communications with the retailer terminal 5 may be carried out through the communication unit 58.

If the information processing terminal 1 is a so-called intelligent LCD (such as an E ink (tradename)) that holds an image on a display on its own at a low power consumption, the information processing terminal 1 includes a display, a controller for generally controlling the entire terminal, and an acquisition unit for acquiring or outputting an image to be displayed. The storage 57 shown in FIG. 7 is dispensed with.

In this arrangement, the information processing terminal 1 holds a single type of authentication image. By successively rewriting the authentication image according to the usage of the authentication image, the user 2 is continuously encouraged to use the authentication image.

FIG. 8 is a functional block diagram in accordance with which the CPU 51 of FIG. 7 executes a predetermined control program.

An image acquisition unit 71 controls the communication unit 58, thereby acquiring the authentication image generated by the information management apparatus 3. For example, in response to an input from the user, the image acquisition unit 71 registers a predetermined original image such as a facial portrait, and the accompanying information associated with the original image in the information management apparatus 3 through the network, and acquires the transmitted authentication image by controlling the communication unit 58.

When another computer registers the original image and the accompanying information and acquires the authentication image, for example, the image acquisition unit 71 acquires the authentication image by communicating with the other computer. The authentication image acquired by the image acquisition unit 71 is output to a display controller 72.

The display controller 72 controls the display 41, thereby displaying the authentication image supplied from the image acquisition unit 71. When the retailer terminal 5 requests the information processing terminal 1 to output the authentication image, the image output unit 73 acquires, from the display controller 72, information representing the authentication image displayed on the display 41, and then outputs the information to the retailer terminal 5 using a wired link or a wireless link.

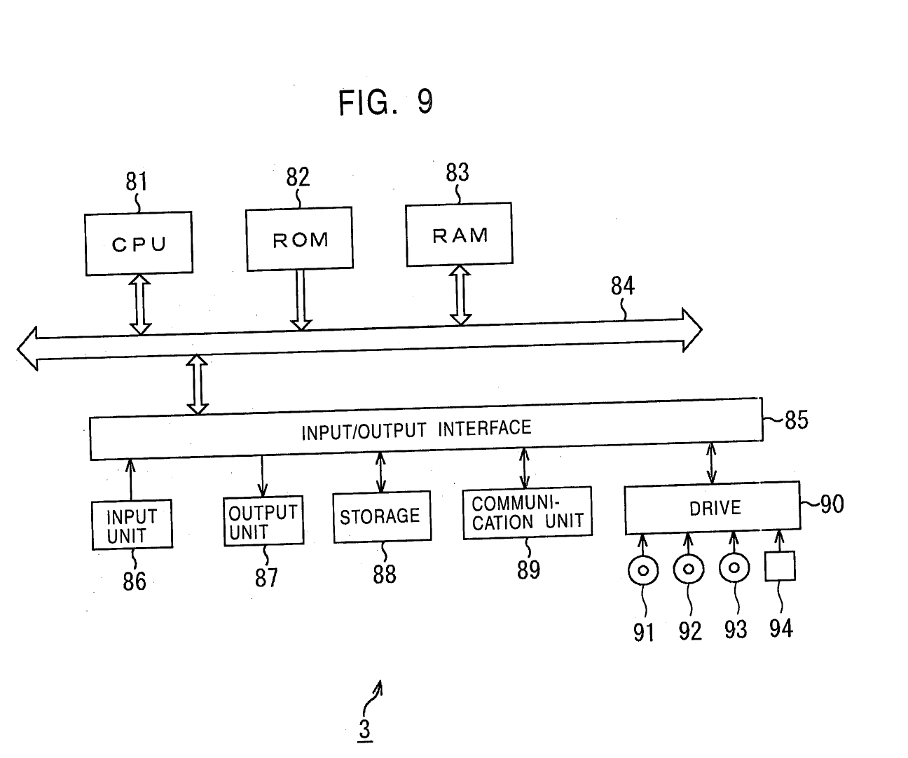

FIG. 9 is a block diagram showing the structure of the information management apparatus 3 of FIG. 1.

The information management apparatus 3 shown in FIG. 9 is substantially identical in structure to the information processing terminal 1 shown in FIG. 9. Portions of the information management apparatus 3 identical to those of the information processing terminal 1 are not discussed here.

A communication unit 89 connected to an input/output interface 85 communicates with the information processing terminal 1, the retailer terminal 5, and the billing apparatus 6 through the network. A drive 90 is connected to the input/output interface 85, as necessary. One of a magnetic disk 91, an optical disk 92, a magneto-optical disk 93, and a semiconductor memory 94 is loaded into the drive 90. A computer program read from the drive 90 is installed on a storage 88 as necessary.

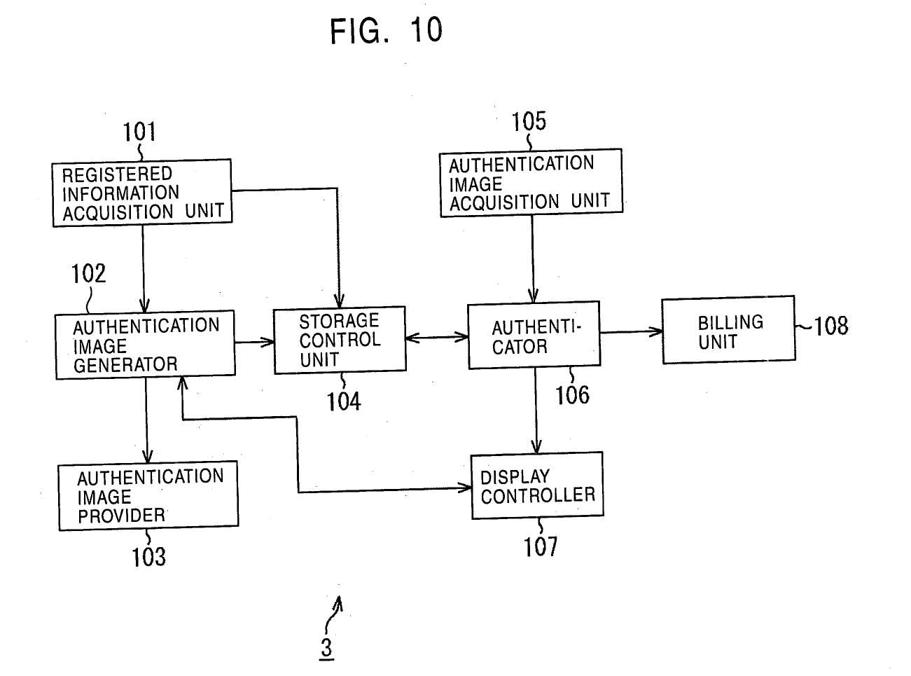

FIG. 10 is a functional block diagram which is executed by a CPU 81 of FIG. 9 in accordance with a predetermined control program.

A registered information acquisition unit 101 controls the communication unit 89, thereby acquiring an image the user has selected as an original image becoming the authentication image, and the information accompanying the original image through a network. The authentication image and the accompanying information acquired by the registered information acquisition unit 101 is output to each of an authentication image generator 102 and a storage control unit 104.

The authentication image generator 102 adds a user name (the name of the user requesting the issue of the authentication image), the year, the month, and the date of manufacture of the authentication image, and predetermined identification (ID) information, as watermark information, to the original image supplied from the registered information acquisition unit 101. The authentication image generator 102 performs a predetermined process, such as a scrambling process, on the accompanying information supplied from the registered information acquisition unit 101, thereby generating an additional information image. The generated additional information image is attached to the original image having the watermark information attached thereto.

The authentication image shown in one of FIGS. 4 and 5 is thus generated. The generated authentication image may be output to each of an authentication image provider 103 and the storage control unit 104. An algorithm for generating the authentication image may be modified as appropriate.

The authentication image provider 103 controls the communication unit 89, thereby transmitting the authentication image, generated by the authentication image generator 102, to the information processing terminal 1 that has requested the information management apparatus 3 to issue the authentication image. The information processing terminal 1 receives the authentication image provided by the authentication image provider 103 directly or through a predetermined apparatus such as a personal computer.

The storage control unit 104 associates the original image supplied from the registered information acquisition unit 101, the additional image, and the authentication image the authentication image generator 102 has generated based on the original image and the additional image, with the identification information of the information processing terminal 1 before storing these pieces of information therewithin. The storage control unit 104 organizes a database of the original image, the accompanying information, and the authentication image in the storage 88 of FIG. 9.

When the retailer terminal 5 requests the information management apparatus 3 to authenticate the authentication image, an authentication image acquisition unit 105 acquires the authentication image transmitted through the network (the authentication image displayed on the information processing terminal 1) and the identification information of the information processing terminal 1, and outputs the acquired information to an authenticator 106. When a billing of the charge for commodities purchased by the user 2 in the retailer store 4 is requested, billing information about the purchased commodities, the number of commodities, and a price for the commodities is acquired by the authentication image acquisition unit 105.

By referencing the information stored in the storage control unit 104, the authenticator 106 checks the authenticity of the authentication image supplied from the authentication image acquisition unit 105, in other words, verifies that the authentication image is authentic without being counterfeited. The results of authentication are reported to the retailer terminal 5 through the network.

Upon being notified of the authenticity of the authentication image by the authenticator 106, a display controller 107 controls the authentication image generator 102 to acquire an update image, and controls the displaying of the authentication image on the information processing terminal 1. More specifically, the display controller 107 rewrites the authentication image displayed on the information processing terminal 1 with the update image.

Furthermore, if the authenticator 106 verifies that the authentication image is authentic, the identification information of the information processing terminal 1 holding the authentication image and billing information are sent from the authenticator 106 to a billing unit 108. The billing unit 108 requests the billing apparatus 6 to perform an accounting process in response to the supplied information.

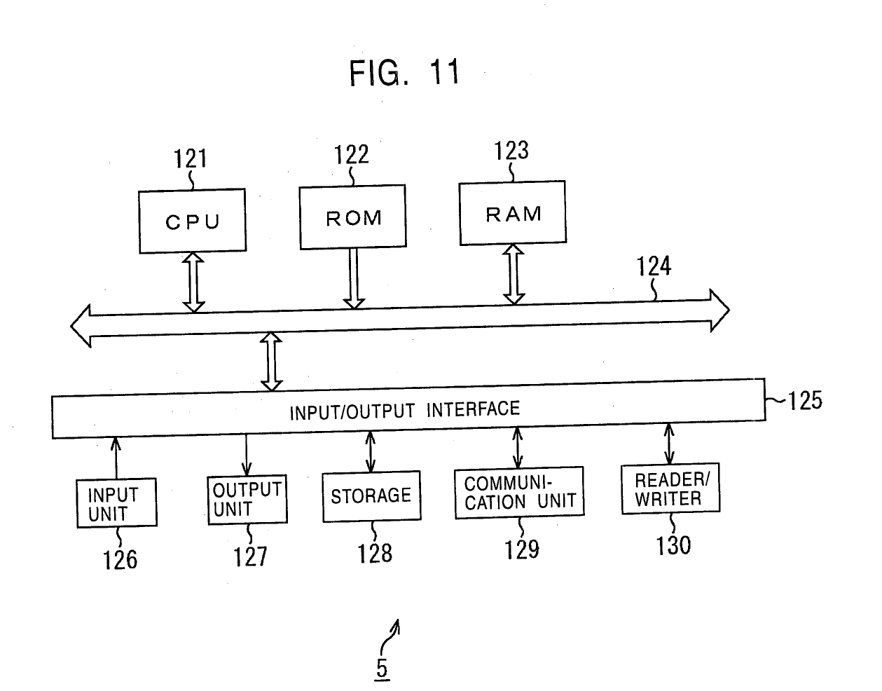

FIG. 11 is a block diagram of a structure of the retailer terminal 5.

The retailer terminal 5 is substantially identical in structure to each of the information processing terminal 1 shown in FIG. 7, and the information management apparatus 3 shown in FIG. 9 except that a reader/writer 130 is contained, and the detail discussion thereof is omitted.

The reader/writer 130 reads the authentication image displayed on the information processing terminal 1 using a wired link or a wireless link, and supplies a CPU 121 with the authentication image through an input/output interface 125 and a bus 124. Upon receiving the authentication image acquired by a communication unit 129, the reader/writer 130 transfers the authentication image to the information processing terminal 1, thereby updating the authentication image on the information processing terminal 1.

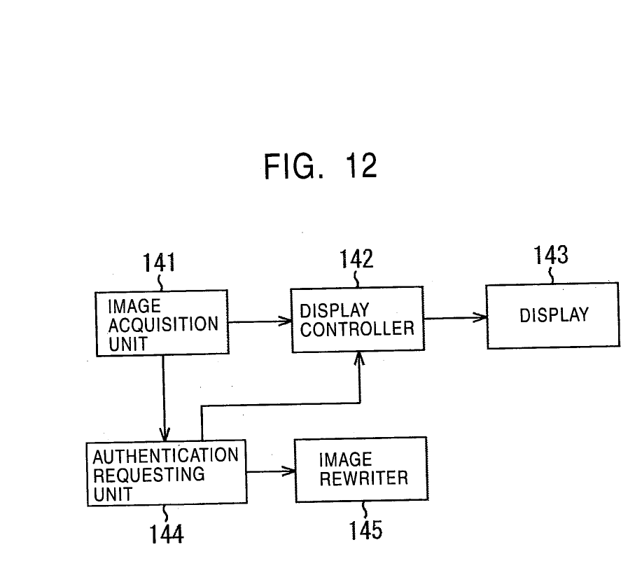

FIG. 12 is a functional block diagram which is executed by the CPU 121 of FIG. 11 in accordance with a predetermined program.

An image acquisition unit 141 controls the reader/writer 130, thereby acquiring information representing the authentication image displayed on the information processing terminal 1. The authentication image acquired by the image acquisition unit 141 is output to each of a display controller 142 and an authentication requesting unit 144.

The display controller 142 controls a display 143 constructed of an LCD, thereby causing the authentication image supplied from the image acquisition unit 141 to be displayed on the display 143. In response to a request from the authentication requesting unit 144, the display controller 142 presents, on the display 143, a message indicating the results of authentication of the authentication image reported by the information management apparatus 3, and thus shows the message to the shop clerk.

The authentication requesting unit 144 controls the communication unit 129, thereby transmitting information representing the authentication image supplied from the image acquisition unit 141 to the information management apparatus 3 through the network, and requesting the information management apparatus 3 to authenticate the authentication image. The information management apparatus 3 authenticates the authentication image. Upon receiving the results of authentication of the authentication image, the authentication requesting unit 144 outputs the results of authentication to the display controller 142.

Upon receiving the information representing the authentication image together with the authentication results, the authentication requesting unit 144 outputs the information representing the authentication image to an image rewriter 145. The authentication requesting unit 144 instructs the image rewriter 145 to rewrite the authentication image displayed on the information processing terminal 1.

The image rewriter 145 controls the reader/writer 130, rewriting and updating the authentication image displayed on the information processing terminal 1 based on the image supplied from the authentication requesting unit 144.

The operation of the information management system of FIG. 1 will now be discussed with reference to flow diagrams.

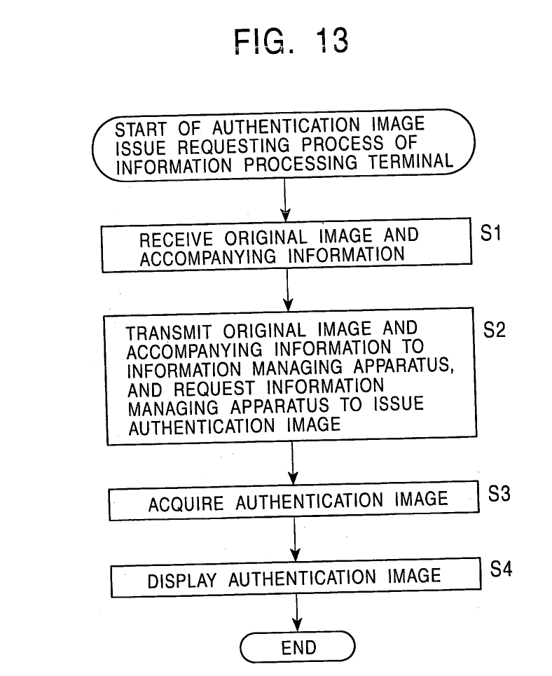

The process of the information processing terminal 1 for requesting the information management apparatus 3 to issue the authentication image is discussed with reference to a flow diagram shown in FIG. 13. As shown, the information processing terminal 1 directly requests the information management apparatus 3 to issue the authentication image.

In step S1, the image acquisition unit 71 in the information processing terminal 1 receives the original image and accompanying information to be registered in the information management apparatus 3 in response to a user input on the input unit 42. The image acquisition unit 71 thus acquires a variety of images such as the facial portrait of the user 2 as the original image used to generate the authentication image, and information such as an image of a fingerprint of the user 2 and a password having predetermined digits as the accompanying information.

In step S2, the image acquisition unit 71 controls the communication unit 58, thereby transmitting the acquired original image and accompanying information to the information management apparatus 3 and requesting the information management apparatus 3 to issue the authentication image.

Upon receiving the authentication image generated in response to the request and sent from the information management apparatus 3, the image acquisition unit 71 acquires the authentication image and outputs the acquired authentication image to the display controller 72 in step S3. The image acquisition unit 71 stores the authentication image in the storage 57 as necessary.

The display controller 72 displays the authentication image supplied from the image acquisition unit 71 on the display 41 in step S4.

The user 2 registers an image of the user's own preference on the information management apparatus 3 in this way. The user 2 can use the thus generated authentication image in the retailer store 4 to identify the user himself. Since the authentication image is issued by simply inputting the preferred image and the predetermined accompanying information, the user 2 easily and quickly acquires information authenticating the user himself.

The information processing terminal 1 directly requests the information management apparatus 3 to issue the authentication image. If another apparatus such as a personal computer other than the information processing terminal 1 requests the information management apparatus 3 to issue the authentication image, steps S1 through S3 shown in FIG. 13 are performed by the other apparatus. The acquired authentication image is then transferred to the information processing terminal 1 through a wired link or a wireless link. The information processing terminal 1 displays the received authentication image on the display 41.

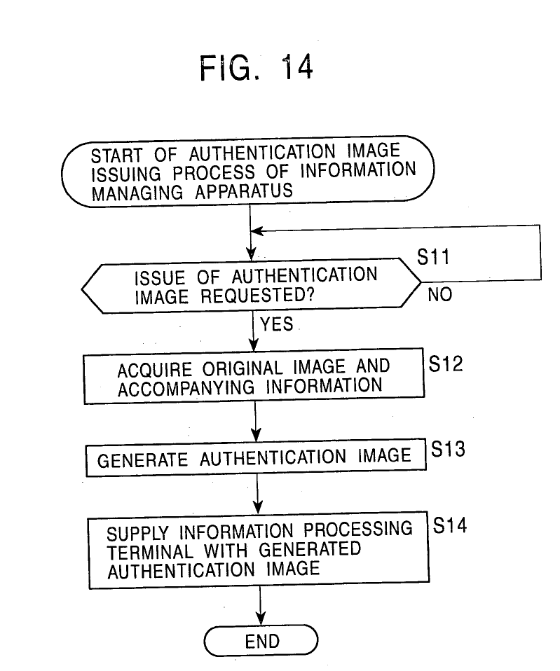

An authentication image issuing process of the information management apparatus 3 performed in response to the process shown in FIG. 13 will now be discussed with reference to a flow diagram shown in FIG. 14.

Based on an output from the communication unit 89, the registered information acquisition unit 101 determines in step S11 whether the information processing terminal 1 has requested the information management apparatus 3 to issue the authentication image. The registered information acquisition unit 101 waits on standby until it is determined that the request to issue the authentication image is placed.

If the registered information acquisition unit 101 determines in step S11 that the request to issue the authentication image is placed, the algorithm proceeds to step S12. The registered information acquisition unit 101 receives the original image and the accompanying information from the information processing terminal 1. The information processing terminal 1 has transmitted the request to issue the authentication image together with the original image and the accompanying information (step S2 in FIG. 13).

The original image and the accompanying information acquired by the registered information acquisition unit 101 are output to the authentication image generator 102. The original image and the accompanying information acquired by the registered information acquisition unit 101 are also supplied to the storage control unit 104. The storage control unit 104 registers the original image and the accompanying information in the storage 88.

In step S13, the authentication image generator 102 generates the authentication image based on the original image and the accompanying information. As already discussed with reference to FIGS. 2 and 3, various pieces of information such as the user name and the year, the month and the date of manufacture of the authentication image are attached to the original image as the watermark information. Furthermore, the additional information image generated based on the accompanying information is attached to the original image. The authentication image generated by the authentication image generator 102 is output to each of the authentication image provider 103 and the storage control unit 104.

In step S14, the authentication image provider 103 transmits, to the information processing terminal 1, the authentication image, generated by the authentication image generator 102, through the communication unit 89.

If the request to issue the authentication image is directly placed by the information processing terminal 1, the authentication image is directly transmitted to the information processing terminal 1. If the request to issue the authentication image is placed by another apparatus other than the information processing terminal 1, the authentication image is transmitted to the other apparatus. If a predetermined apparatus has instructed the information management apparatus 3 to directly transmit the authentication image to the information processing terminal 1, the authentication image provider 103 provides the information processing terminal 1 with the authentication image in response to the request.

The information processing terminal 1 is thus provided with the authentication image, and the display 41 presents the authentication image on the screen thereof (step S4 in FIG. 13).

Since the algorithm for generating the authentication image is managed by only an operator of the information management apparatus 3 (the operator of the information management system shown in FIG. 1), security of the authentication image is assured.

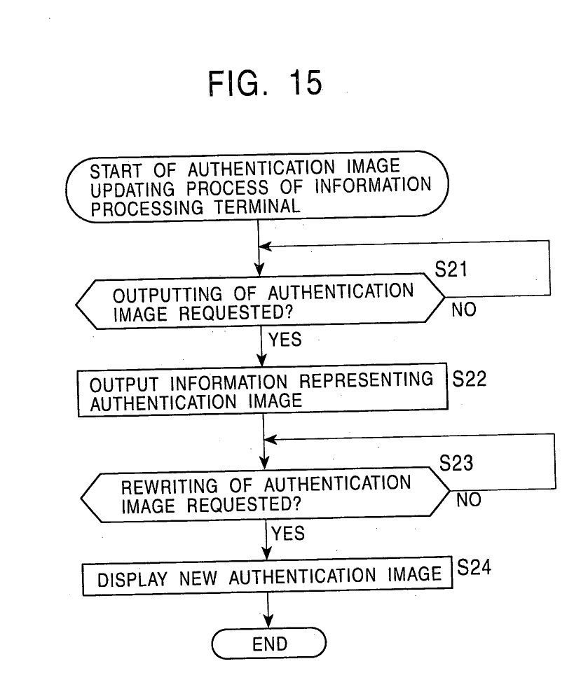

An authentication image updating process of the information processing terminal 1 performed when the user 2 shows the authentication image is discussed with reference to a flow diagram shown in FIG. 15.

The process shown in FIG. 15 is performed when the authentication image displayed on the information processing terminal 1 is output to the retailer terminal 5 to authenticate a membership of the user 2 for the retailer store 4 or to pay for a commodity purchased by the user 2 after the user 2 purchases the commodity in the retailer store 4.

If the image output unit 73 in the information processing terminal 1 determines in step S21 that the retailer terminal 5 has requested the information processing terminal 1 to output the authentication image, the algorithm proceeds to step S22. The image output unit 73 acquires information representing the authentication image displayed on the display 41 from the display controller 72, and outputs the information to the reader/writer 130 of the retailer terminal 5 using a wired link or a wireless link.

For example, when a shop clerk performs a predetermined operation on the retailer terminal 5 with the information processing terminal 1 installed on or close to the reader/writer 130, a request to output the authentication image is placed on the information processing terminal 1.

The information processing terminal 1 outputs the identification information such as the password of the user 2 together with the information representing the authentication image.

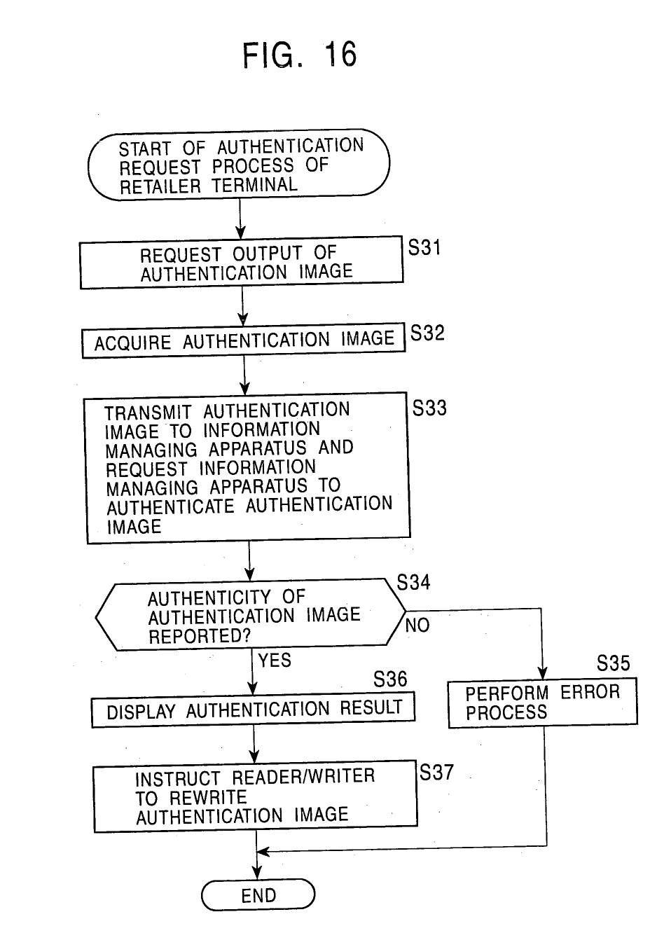

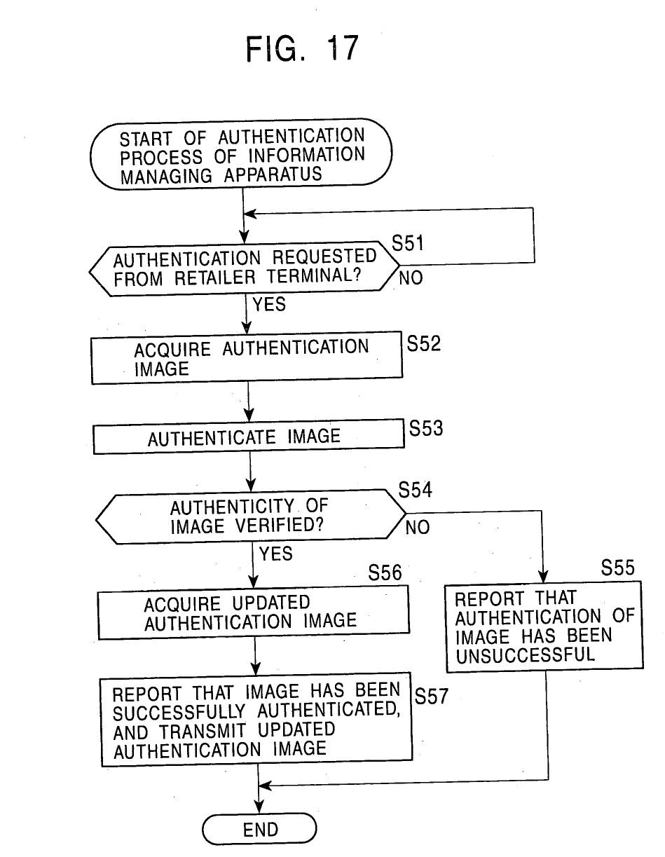

The authentication image output in step S22 is transmitted to the information management apparatus 3 through the retailer terminal 5. The information management apparatus 3 authenticates the authentication image (step S53 in FIG. 17). When the authentication image is verified as being authentic, the retailer terminal 5 instructs the information processing terminal 1 to rewrite the already displayed authentication image with a new authentication image generated by the information management apparatus 3 (an update image) (step S37 in FIG. 16).

In step S23, the image acquisition unit 71 determines whether the reader/writer 130 transfers the update image to request the information processing terminal 1 to rewrite the authentication image. The image acquisition unit 71 waits on standby until it is determined that the request to rewrite is placed.

If the image acquisition unit 71 determines in step S23 that the request to rewrite the authentication image is placed, the update image transferred from the reader/writer 130 is output to the display controller 72. The algorithm then proceeds to step S24. The update image is then displayed on the display 41.

The update image generated in response to the usage of the retailer store 4 is displayed on the information processing terminal 1 as shown in FIG. 6.

An authentication requesting process of the retailer terminal 5 performed in response to the process shown in FIG. 15 is now discussed with reference to a flow diagram shown in FIG. 16.

If a shop clerk instructs the retailer terminal 5 to read the authentication image displayed on the information processing terminal 1 with the information processing terminal 1 installed on or close to the reader/writer 130, the image acquisition unit 141 controls the reader/writer 130 in step S31, thereby requesting the information processing terminal 1 to output the authentication image displayed thereon.

In response to the request, the information processing terminal 1 outputs information representing the authentication image through a wired link or a wireless link. In step S32, the image acquisition unit 141 controls the reader/writer 130, thereby acquiring the information representing the authentication image. The acquired information representing the authentication image is output to each of the display controller 142 and the authentication requesting unit 144.

The display controller 142 displays the authentication image on the display 143 based on the information supplied from the image acquisition unit 141.

In step S33, the authentication requesting unit 144 controls the communication unit 129, thereby transmitting the authentication image output from the information processing terminal 1 to the information management apparatus 3 and requesting the information management apparatus 3 to authenticate the authentication image. In response, the information management apparatus 3 authenticates the authentication image based on pre-registered information, and reports the result of authentication.

In step S34, the authentication requesting unit 144 determines whether the information management apparatus 3 reports the authenticity of the authentication image. If the authentication requesting unit 144 determines that the information management apparatus 3 has reported that the authentication image is not authentic, the algorithm proceeds to step S35 where an error process is performed.

In the error process, the display 143 shows, to the shop clerk and the user 2, a message conveying that the transaction is denied because of a possibility of counterfeiting of the authentication image. Without any fraud, only the user 2 who has registered information such as the original image and the accompanying information is permitted to use the retailer store 4.

If the authentication requesting unit 144 determines in step S34 that the information management apparatus 3 has reported the authenticity of the authentication image, the algorithm proceeds to step S36. The reporting of the authenticity of the authentication image is then output to the display controller 142. The display 143 then presents a message conveying that the transaction is possible because of the authenticity of the authentication image.

The authentication requesting unit 144 outputs the update image together with the reporting of the authentication result, sent from the information management apparatus 3, to the image rewriter 145.

In step S37, the image rewriter 145 controls the reader/writer 130, thereby transferring the update image to the information processing terminal 1. The image rewriter 145 requests the information processing terminal 1 to rewrite the already displayed authentication image with the update image newly generated by the information management apparatus 3.

In response to the request from the image rewriter 145, the information processing terminal 1 rewrites the authentication image. For example, the authentication image shown in FIG. 6, into which the authentication image shown in FIG. 4 is updated, appears (in step S24 in FIG. 15).

An authentication process of the information management apparatus 3 performed in response to the process shown in FIG. 16 is discussed with reference to a flow diagram shown in FIG. 17.

Based on the output from the communication unit 89, the authentication image acquisition unit 105 determines in step S51 whether the retailer terminal 5 has requested the information management apparatus 3 to authenticate the authentication image. The authentication image acquisition unit 105 waits on standby until it is determined that the retailer terminal 5 has requested the information management apparatus 3 to authenticate the authentication image. If the authentication image acquisition unit 105 determines that the request to authenticate the authentication image has been placed, the algorithm proceeds to step S52. The authentication image acquisition unit 105 acquires the authentication image sent from the retailer terminal 5.

If the information identifying the information processing terminal 1 and the user 2 is also transmitted in addition to the authentication image, the authentication image acquisition unit 105 also acquires the information, and outputs the authentication image together with the information to the authenticator 106.

Based on the information supplied from the authentication image acquisition unit 105, the authenticator 106 references the information, the user 2 has pre-registered using the storage control unit 104. The authenticator 106 then authenticates the authentication image. More specifically, to verify authenticity of the authentication image, the authenticator 106 determines whether the watermark information extracted from the original image and the accompanying information acquired from the additional information image coincide with pre-registered information.

The display controller 107 determines in step S54 whether the authenticator 106 has verified the authenticity of the authentication image. If the display controller 107 determines in step S54 that the authenticator 106 has verified that the authentication image is unauthentic, in other words, that the authenticator 106 has verified that there is a possibility of counterfeiting of the authentication image, the algorithm proceeds to step S55. The display controller 107 controls the communication unit 89, thereby notifying so the retailer terminal 5.

If the display controller 107 determines in step S54 that the authenticator 106 has verified the authenticity of the authentication image, the algorithm proceeds to step S56. The display controller 107 controls the authentication image generator 102, thereby acquiring an authentication image to be used to update the current authentication image. For example, depending on the usage of the retailer store 4 by the user 2, such as the amounts of money to be paid for and the frequency of uses of the retailer store 4, the authentication image generator 102 performs a predetermined image processing on the authentication image requested to be authenticated, thereby generating an update image. If a plurality of original images are pre-registered, the authentication image generator 102 reads a still unused original from the storage 88 through the storage control unit 104, and generates an update image based on the read original image.

In step S57, the display controller 107 transmits, to the retailer terminal 5 through the network, the generated update image together with a message conveying that the authentication image requested to be authenticated is authentic.

Each time the authentication image displayed on the information processing terminal 1 is used, a different authentication image is newly generated and is then transmitted to the information processing terminal 1.

If a plurality of original images expressing a continuous scene are pre-registered, an authentication image is generated in the order of registration of the original images, and resulting authentication images are thus successively provided.

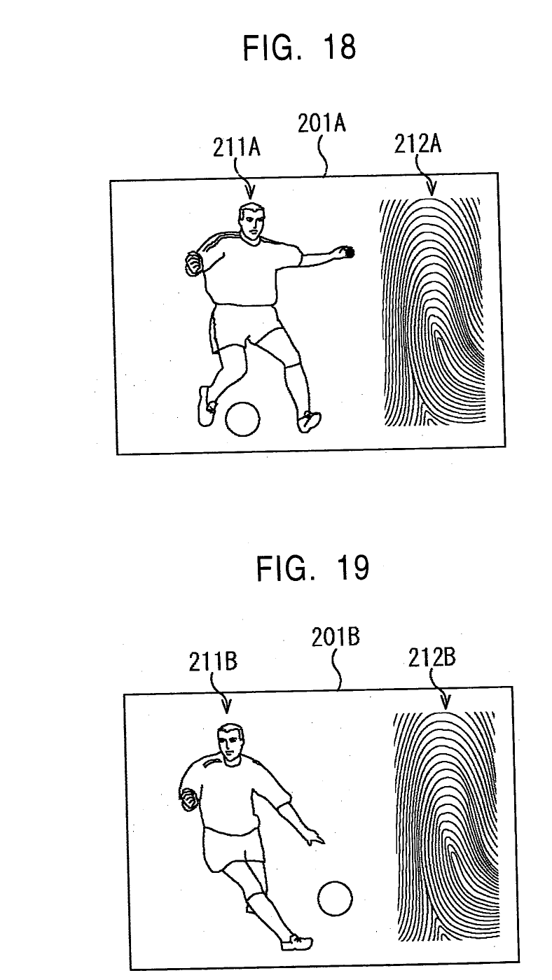

FIGS. 18 through 20 show three authentication images generated based on original images expressing a continuous scene. For example, a authentication image 201A shown in FIG. 18 is provided to the information processing terminal 1 during registration of the original images. When the authentication image 201A is then used (after the authenticity of the authentication image 201A is verified), an authentication image 201B shown in FIG. 19 is provided to the information processing terminal 1 next.

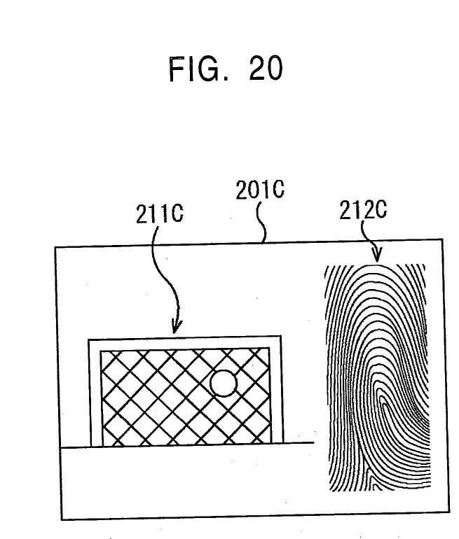

When the authentication image 201B shown in FIG. 19 is used in the retailer store 4, an authentication image 201C shown in FIG. 20 is provided to the information processing terminal 1 based on the pre-registered original images.

An original image 211A shown in FIG. 18 is the one expressing a scene immediately prior to the shooting of a soccer player, an original image 211B shown in FIG. 18 is the one expressing a scene immediately subsequent to the shooting of the soccer player, and an original image 211C is the one expressing a scene at the moment the soccer player shoots a goal.

Each time the authentication image is used, the authentication image is updated. The user 2 expects a next change in the authentication image, which arouses the user interest leading to repeated use of the authentication image by the user 2.

The request to issue the authentication image and the use of the issued authentication image are performed by the same person (the user 2) in the above discussion. Alternatively, an authentication image generated in response to a request from an owner of the retailer store 4 may be issued for a customer of the retailer store 4, and the authentication image may be used by the customer.

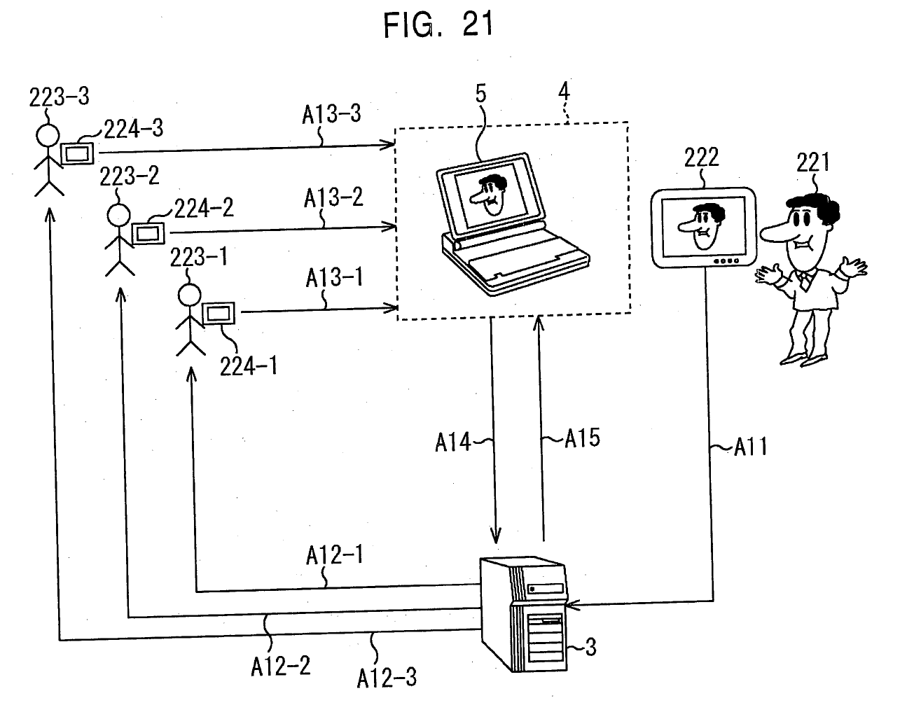

FIG. 21 shows a system configuration of such an information management system. Elements identical to those discussed with reference to FIG. 1 are designated with the same reference numerals.

An information processing terminal 222 registers, in an information management apparatus 3, information including an original image selected by the owner 221 of the retailer store 4, accompanying information, and an authentication image generated based on these pieces of information, and target destination of the authentication image such as addresses of information processing terminals 224-1 through 224-3 respectively owned by customers 223-1 through 223-3 (see an arrow-headed solid line A11 in FIG. 21). The information management apparatus 3 generates the authentication image in the same process as the one already discussed with reference to FIG. 14. The authentication image is then issued to each of the information processing terminals 224-1 through 224-3 (see arrow-headed solid lines A12-1 through A12-3).

The information processing terminals 224-1 through 224-3 acquire the authentication image from the information management apparatus 3, and display the authentication image on the displays thereof.

For example, when the customer 223-1 purchases a commodity in the retailer store 4, the processes discussed with reference to FIGS. 15, 16, and 17 are performed by the information processing terminal 224-1, the retailer terminal 5, and the information management apparatus 3. A authentication image newly produced depending on the usage of the authentication image is provided to the information processing terminal 224-1 through the retailer terminal 5 (see an arrow-headed solid line A15).

The owner 221, namely, the operator of the retailer store 4, may distribute, among the customers, the authentication image that is generated based on various images of preferences such as advertisements of the retailer store 4, and an image representing a map guiding to the retailer store 4. These images are updated each time the customer uses the retailer store 4, and up-to-date information is thus provided as the authentication image.

The information management system shown in FIG. 21 may generate the authentication image containing amount information relating to the amounts of money already paid by the customers 223-1 through 223-3, and issues the authentication image to each of the customers 223-1 through 223-3.

The authentication image displayed on each of the information processing terminals 224-1 through 224-3 represents the amount of money, and has a function of a prepaid card.

When one of the customers 223-1 through 223-3 purchases a commodity, the information management apparatus 3 newly generates an authentication image representing a remaining amount of money as a result of subtraction of the payment for the commodity, and then updates the authentication image on each of the information processing terminals 224-1 through 224-3.

The operation of the information management system shown in FIG. 21 is now discussed, wherein the authentication image generated in accordance with the amount of money already paid by the user 2 is distributed, and used.

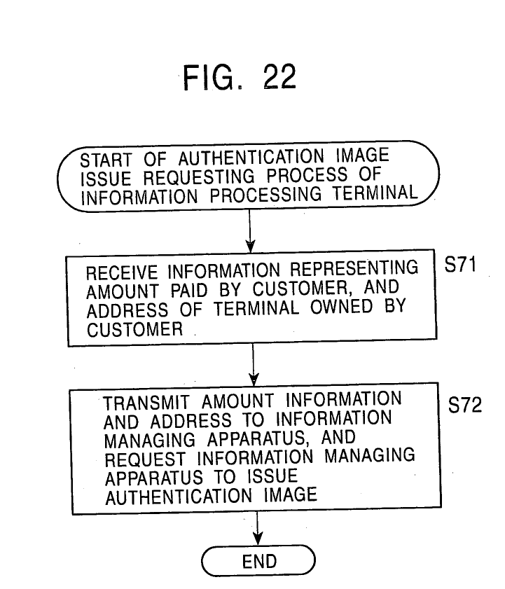

An authentication image issue requesting process of the information processing terminal 222 for requesting the issue of the authentication image corresponding to the amount paid by the customer is discussed with reference to a flow diagram shown in FIG. 22.

In the process shown in FIG. 22, the owner 221 pre-registers the original image and the accompanying information in the information management apparatus 3. The authentication image generated based on the pre-registered information is issued to the terminal of a customer designated later as a destination. The pre-registered original image may represent the advertisement of the retailer store 4 and the map guiding to the retailer store 4. The generated authentication image is then issued to the customer.

The information processing terminal 222 is substantially identical in structure to the information processing terminal 1 shown in FIGS. 7 and 8. The information processing terminal 222 is now discussed with reference to FIGS. 7 and 8.

In step S71, the image acquisition unit 71 in the information processing terminal 222 receives an input from the input unit 42, thereby acquiring amount information representing an amount of money paid by the customer, and an address of the terminal, owned by the customer who paid the amount, as a destination of the authentication image.

In step S72, the image acquisition unit 71 transmits the amount information and the address to the information management apparatus 3, and requests the information management apparatus 3 to issue the authentication image to the terminal designated by the address.

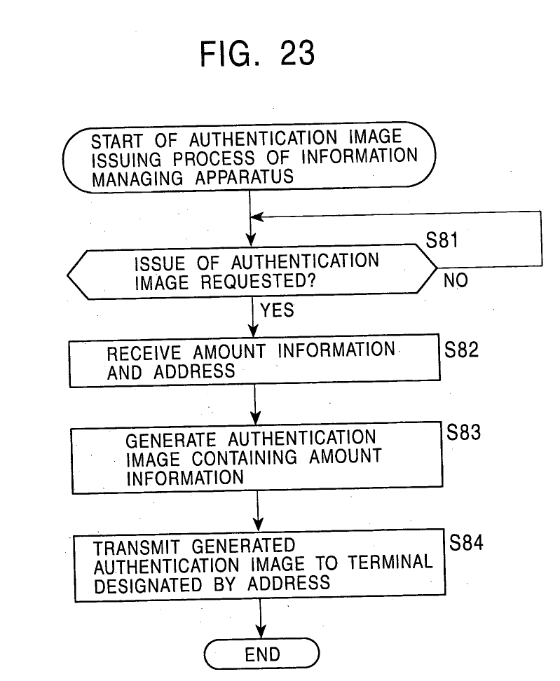

An authentication image issuing process of the information management apparatus 3 performed in response to the process shown in FIG. 22 is now discussed with reference to a flow diagram shown in FIG. 23.

The process shown in FIG. 23 is substantially identical to the process discussed with reference to. FIG. 14. More specifically, the registered information acquisition unit 101 determines in step S81 whether the information processing terminal 222 has requested the information management apparatus 3 to issue the authentication image. If the registered information acquisition unit 101 determines that the request to issue the authentication image is placed, the algorithm proceeds to step S82. The registered information acquisition unit 101 then acquires the amount information and the address as the destination of the authentication image from the information processing terminal 222.

The amount information and the address, acquired by the registered information acquisition unit 101, are output together with the pre-registered original image and accompanying information to the authentication image generator 102. Identification information identifying the pre-registered original image and the accompanying information are transmitted from the information processing terminal 222 to the information management apparatus 3. The original image and the accompanying information are read based on the identification information.

The authentication image generator 102 encodes the amount information using a predetermined algorithm in step S83, contains the amount information in the original image or the additional information image. The authentication image generator 102 thus generates the authentication image in which the amount information is represented in a visible or invisible fashion. The generated authentication image is issued to the terminal having the address designated by the information processing terminal 222 (the terminal owned by the customer) in step S84.

For example, when the customer 223-1 has already paid $30, the information processing terminal 222 registers, in the information management apparatus 3, information representing the amount and the address of the information processing terminal 224-1 of the customer 223-1. The authentication image containing the amount information representing $30 is issued to the information processing terminal 224-1.

When the customer 223-1 purchases a commodity at the retailer store 4, and pays the price for the commodity in accordance with the amount information represented by the authentication image, the information processing terminal 224-1 having the same structure as the one shown in FIGS. 7 and 8 performs the same process as the one discussed with reference to FIG. 15. The authentication image is then transmitted to the retailer terminal 5.

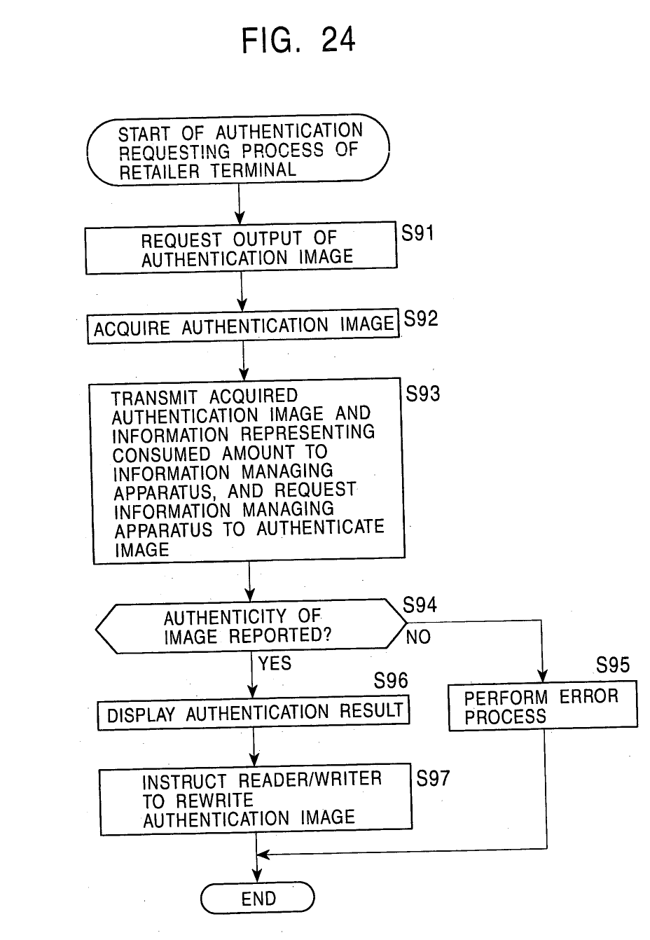

A process of the retailer terminal 5 at the retailer store 4 performed when the authentication image containing the amount information is shown is discussed below with reference to a flow diagram shown in FIG. 24.

The process in steps S91 and S92 is identical to that performed in steps S31 and S32 shown in FIG. 16. In steps S91 and S92, the image acquisition unit 141 controls the reader/writer 130, thereby acquiring the authentication image displayed on the information processing terminal 224-1.

In step S93, the authentication requesting unit 144 transmits, to the information management apparatus 3, the acquired authentication image together with the amount information representing the amount of money spent by the customer 223-1 at the retailer store 4. The amount information transmitted here indicates the one input on the retailer terminal 5 by a shop clerk at the retailer store 4 or by the customer 223-1 himself.

When the information management apparatus 3 verifies that the authentication image is authentic, the amount spent by the user 2 is subtracted from the amount represented by the authentication image. The authentication image containing the remaining amount is generated as an update image.

The process in steps S94 through S97 is identical to the process in steps S34 through S37 in FIG. 16. More specifically, the authentication requesting unit 144 determines whether or not the authenticity of the authentication image has been reported. If the authentication requesting unit 144 determines in step S94 that the authenticity of the authentication image has not been reported because of a possibility of counterfeiting of the authentication image, the algorithm proceeds to step S95. An error process is then performed.

If the authentication requesting unit 144 determines in step S94 that the information management apparatus 3 has reported the authenticity of the authentication image, a message to that effect is displayed in step S96. The algorithm proceeds to step S97. The retailer terminal 5 instructs the information processing terminal 224-1 to rewrite the authentication image.

A new authentication image requested to be displayed may be an image containing information representing an amount of money remaining after the amount spent by the customer 223-1 is removed from the preceding amount.

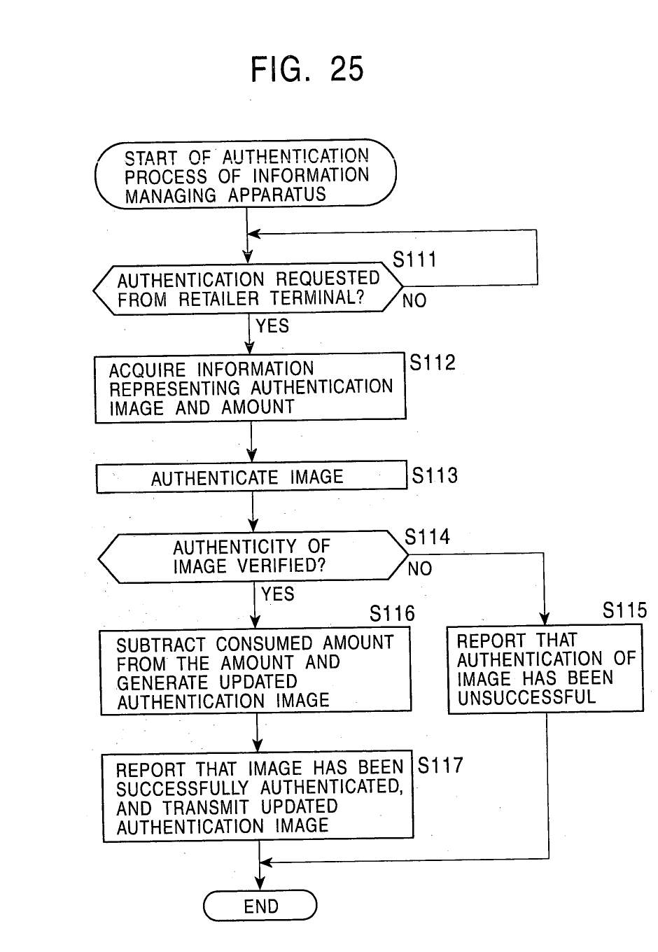

An authentication process of the information management apparatus 3 performed in response to the process shown in FIG. 24 will now be discussed with reference to a flow diagram shown in FIG. 25.

The process shown in FIG. 25 is substantially identical to the process discussed with reference to FIG. 17. More specifically, when the retailer terminal 5 requests the information management apparatus 3 to authenticate the authentication image, the authentication image acquisition unit 105 acquires the authentication image and the information representing the amount of money spent by the customer 223-1 in step S112. In step S113, the authenticator 106 authenticates the authentication image.

If the authenticator 106 in step S114 determines that the authentication image is authentic, the amount spent by the customer 223-1 is subtracted from the amount information (remaining amount information) contained in the received authentication image. In step S116, an authentication image with the remaining amount information attached thereto is generated as an update image.

In step S117, the newly generated update image is supplied to the information processing terminal 224-1 through the retailer terminal 5, and is then displayed in the same way as in step S24 in FIG. 15.

The authentication image containing a variety of pieces of information may be held in the terminal used by the customer.

In the above discussion, the authentication image is a still image. A moving authentication image may be issued. For example, a frame within a predetermined range in a moving image is issued as an authentication image to arouse the user's interest in a next authentication image.

The information management apparatus 3, the retailer terminal 5, and the billing apparatus 6 are physically separate devices. Alternatively, the information management apparatus 3, the retailer terminal 5, and the billing apparatus 6 may be integrated into a single apparatus. Alternatively, these apparatuses may be combined physically or logically to configure one of the information management systems shown in FIGS. 1 and 21, for example, an apparatus having the functions of the information management apparatus 3 and the retailer terminal 5, an apparatus having the functions of the information management apparatus 3 and the billing apparatus 6, or an apparatus having the retailer terminal 5 and the billing apparatus 6 may be implemented.

The above series of processes is performed using hardware elements having the functions thereof. Alternatively, the above series of processes may be performed using software.

If the processes are performed using software, a program of the software may be installed, through a network or from a recording medium, in a computer built in dedicated hardware or in a general-purpose personal computer that performs a variety of functions with a variety of programs installed therein.

As shown in FIG. 9, the recording medium may be not only a package medium distributed to supply the user with the program, separate from the apparatus, such as one of the magnetic disk 91 (including a flexible disk), the optical disk 92 (including CD-ROM (Compact Disk-Read Only Memory), and DVD (Digital Versatile Disk)), the magneto-optical disk 93 (including a Mini-Disk (MD) (tradename)), and the semiconductor memory 94, each storing the program, but also one of the ROM 82 and the storage 88 such as a hard disk, each storing the program, supplied in the apparatus to the user.

In the specification of the present invention, the steps describing the program stored in the recording medium may be performed sequentially as described in time axis. But the steps are not necessarily sequentially performed in time axis, and may be performed in parallel or separately.

The system in the specification of the present invention refers to the one including a plurality of apparatuses.

In accordance with the embodiments of the present invention, the user's interest is aroused to repeatedly use information identifying the user himself.

In accordance with the embodiments of the present invention, the turnover of the retailer stores using the information is expected to rise.

What is claimed is:

1. An information management system comprising: an information management apparatus for producing an authentication image to be used to authenticate a user, and an information processing terminal for displaying the authentication image provided by the information management apparatus,
wherein the information management apparatus comprises:
generating means for generating a first authentication image based on a predetermined original image,
first providing means for providing the information processing terminal with the first authentication image generated by the generating means,
authenticating means for authenticating the first authentication image which is provided by the information processing terminal through a control device that controls the reading of an image displayed on the information processing terminal, and
display control means for displaying a second authentication image instead of the first authentication image displayed on the information processing terminal when the authenticating means verifies that the first authentication image is authentic, and
wherein the information processing terminal comprises:
acquisition means for acquiring the first authentication image,
display means for displaying the first authentication image acquired by the acquisition means, and
second providing means for providing the information management apparatus with the first authentication image, displayed by the display means, through the control device,
wherein the display means displays the second authentication image instead of the first authentication image when the information management apparatus verifies that the first authentication image provided by the second providing means is authentic.

2. An information management method for an information management system including an information management apparatus for producing an authentication image to be used to authenticate a user, and an information processing terminal for displaying the authentication image provided by the information management apparatus, the information management method comprising an information management method for the information management apparatus, and an information processing method for the information processing terminal,
wherein the information management method for the information management apparatus comprises:
a generating step for generating a first authentication image based on a predetermined original image,
a first providing step for providing the information processing terminal with the first authentication image generated in the generating step,
an authenticating step for authenticating the first authentication image which is provided by the information processing terminal through a control device that controls the reading of an image displayed on the information processing terminal, and
a display control step for displaying a second authentication image instead of the first authentication image displayed on the information processing terminal when the authenticating step verifies that the first authentication image is authentic, and
wherein the information processing method for the information processing terminal comprises:
an acquisition step for acquiring the first authentication image,
a display step for displaying the first authentication image acquired in the acquisition step, and
a second providing step for providing the information management apparatus with the first authentication image, displayed in the display step, through the control device,
wherein the display step comprises displaying the second authentication image instead of the first authentication image when the information management apparatus verifies that the first authentication image provided in the second providing step is authentic.

3. An information management apparatus for generating an image to be displayed on a predetermined information processing terminal, the information management apparatus comprising:
generating means for generating a first authentication image to be used to authenticate a user based on a predetermined original image,
providing means for providing the information processing terminal with the first authentication image generated by the generating means,
authenticating means for authenticating the first authentication image which is provided by the information processing terminal through a control device that controls the reading of an image displayed on the information processing terminal, and
display control means for displaying a second authentication image instead of the first authentication image displayed on the information processing terminal when the authenticating means verifies that the first authentication image is authentic.

4. An information management apparatus according to claim 3, wherein the generating means generates further the second authentication image when the authentication means verifies that the first authentication image is authentic, and
wherein the display control means displays the second authentication image on the information processing terminal by providing the information processing terminal with the second authentication image generated by the generating means.

5. An information management apparatus according to claim 3, wherein the generating means generates the first authentication image containing first amount information based on a first amount of money already paid by the user.

6. An information management apparatus according to claim 2, wherein the generating means subtracts an amount spent by the user from the amount represented by the first amount information when the authenticating means verifies that the first authentication image is authentic, and generates the second authentication image containing second amount information based on a resulting remaining amount of money.

7. An information management apparatus according to claim 3, wherein the first authentication image and the second authentication image constitute a continuous scene.

8. An information management apparatus according to claim 3, wherein each of the first authentication image and the second authentication image is one of a still image and a moving image.

9. An information management method for an information management apparatus for generating an image to be displayed on a predetermined information processing terminal, the information management method comprising:
a generating step for generating a first authentication image to be used to authenticate a user based on a predetermined original image,
a providing step for providing the information processing terminal with the first authentication image generated in the generating step,
an authenticating step for authenticating the first authentication image which is provided by the information processing terminal through a control device that controls the reading of an image displayed on the information processing terminal, and
a display control step for displaying a second authentication image instead of the first authentication image displayed on the information processing terminal when the authenticating step verifies that the first authentication image is authentic.

10. A computer program for generating an image to be presented on a predetermined information processing terminal, the computer program comprising program codes for performing:
a generating step for generating a first authentication image to be used to authenticate a user based on a predetermined original image,
a providing step for providing the information processing terminal with the first authentication image generated in the generating step,
an authenticating step for authenticating the first authentication image which is provided by the information processing terminal through a control device that controls the reading of an image displayed on the information processing terminal, and
a display control step for displaying a second authentication image instead of the first authentication image displayed on the information processing terminal when the authenticating step verifies that the first authentication image is authentic.

11. An information processing terminal for displaying an authentication image provided by an information management apparatus that generates the authentication image to be used to authenticate a user, the information processing terminal comprising:
acquisition means for acquiring a first authentication image generated based on a predetermined original image,
display means for displaying the first authentication image acquired by the acquisition means, and
providing means for providing the information management apparatus with the first authentication image, displayed by the display means, through a control device that controls the reading of an image,
wherein the display means displays the second authentication image instead of the first authentication image when the information management apparatus verifies that the first authentication image provided by the providing means is authentic.

12. An information processing terminal according to claim 11, wherein the acquisition means further acquires the second authentication image from the information management apparatus when the first authentication image provided by the providing means is verified as being authentic, and
wherein the display means displays the second authentication image acquired by the acquisition means instead of the first authentication image.

13. An information processing terminal according to claim 11, wherein the first authentication image contains first amount information based on a first amount of money already paid by the user.

14. An information processing terminal according to claim 13, wherein the second authentication image contains second amount information based on a remaining amount which is obtained by subtracting an amount spent by the user from the amount represented by the first amount information.

15. An information processing terminal according to claim 11, wherein the first authentication image and the second authentication image constitute a continuous scene.

16. An information processing terminal according to claim 11, wherein each of the first authentication image and the second authentication image is one of a still image and a moving image.

17. An information processing method for an information processing terminal for displaying an authentication image provided by an information management apparatus that generates the authentication image to be used to authenticate a user, the information processing method comprising:
an acquisition step for acquiring a first authentication image generated based on a predetermined original image,
a display step for displaying the first authentication image acquired in the acquisition step, and
a providing step for providing the information management apparatus with the first authentication image, displayed in the display step, through a control device that controls the reading of an image,
wherein the display step comprises displaying the second authentication image instead of the first authentication image when the information management apparatus verifies that the first authentication image provided in the providing step is authentic.

18. A computer program for displaying an authentication image provided by an information management apparatus that generates the authentication image to be used to authenticate a user, the computer program comprising program codes for performing:
an acquisition step for acquiring a first authentication image generated based on a predetermined original image,
a display step for displaying the first authentication image acquired in the acquisition step, and
a providing step for providing the information management apparatus with the first authentication image, displayed in the display step, through a control device that controls the reading of an image,
wherein the display step comprises displaying the second authentication image instead of the first authentication image when the information management apparatus verifies that the first authentication image provided in the providing step is authentic.
